(19) United States
(12) Patent Application Publication
(10) Pub. No.: US 2026/0286752 A1
(43) Pub. Date: Sep. 24, 2026

(54) DOOR CHECKER FOR VEHICLE

(71) Applicant: DELTA KOGYO CO., LTD., Hiroshima (JP)

(72) Inventors: Yuya ISHIHARA, Hiroshima (JP); Tetsuya OBATA, Hiroshima (JP)

(73) Assignee: DELTA KOGYO CO., LTD., Hiroshima (JP)

(21) Appl. No.: 19/474,694

(22) PCT Filed: Apr. 3, 2024
(86) PCT No.: PCT/JP2024/013831

§ 371 Date: Oct. 10, 2025

(30) Foreign Application Priority Data
Apr. 28, 2023 (JP) 2023-074788

(51) Int. Cl. E05C 17/20

(52) U.S. Cl. CPC E05C 17/203

(57) ABSTRACT

A vehicle door checker includes a check plate, a housing, a sliding guide, and an elastic member. The housing allows insertion of the check plate therein, and is attached to other of a body and a door. The housing includes a first housing member and a second housing member. The first housing member is made of resin material, and has a basal part with one main face to come into contact with the other of the body and the door, and an arch part protruding from other main face of the basal part that is opposite to the one main face, the basal part and the arch part being integrally formed. The second housing member is made of resin material, accommodates the sliding guide and the elastic member, and is fixedly attached to the first housing member through insertion into a hollow defined between the basal part and the arch part.

### TECHNICAL FIELD

The present invention relates to a vehicle door checker.

### BACKGROUND ART

Patent Literature 1 discloses a door checker for an automobile. The door checker disclosed in Patent Literature 1 includes a check link, a housing, a pair of shoes, and a pair of coil springs. The check link is a long member and has a detent surface which is uneven. The check link has one end to be attached to a body of the automobile. The housing includes: a casing made of metal and having a through hole that allows insertion of the check link therein; and a casing cover made of metal, fixedly attached to a portion closer to an opening of the casing, and having a through hole that allows insertion of the check link therein. The housing is arranged inside a door and attached to the door.

The pair of shoes are accommodated in the housing and being in contact with the detent surface of the check link. The pair of coil springs are accommodated in the housing and elastically urge the shoes toward the detent surface of the check link.

Unfortunately, the door checker disclosed in Patent Literature 1 still needs improvement in terms of its product weight and quality. Specifically, the door checker in Patent Literature 1 in which the casing and the casing cover both made of metal constitute the housing has a disadvantage that the product weight is heavy.

Besides, the door checker in Patent Literature 1 in which the casing and the casing cover both made of metal constitute the housing as described above has another disadvantage related to the quality, such as occurrence of noise attributed to contact of the coil spring made of metal and accommodated in the housing with an inner surface of the casing or the casing cover when the coil spring extends.

### CITATION LIST

### Patent Literature

Patent Literature 1: Japanese Unexamined Patent Publication No. 2017-197945

The present invention has been accomplished to overcome the disadvantages described above, and has an object of providing a vehicle door checker that achieves weight reduction and high quality.

A vehicle door checker according to one aspect of the present invention is a vehicle door checker to be assembled between a body and a door of a vehicle, and includes a check plate, a housing, a sliding guide, and an elastic member. The check plate is a long link member having one end to be attached to one of the body and the door, and having at least one main surface being an uneven surface. The housing is configured to allow insertion of the check plate therein and to be attached to the other of the body and the door. The sliding guide is configured to guide the check plate by coming into sliding contact with the at least one main surface when the check plate moves relative to the housing in a longitudinal direction of the check plate. The elastic member elastically urges the sliding guide in a direction in which the sliding guide comes into contact with the check plate.

In the vehicle door checker in the aspect, the housing includes a first housing member and a second housing member. The first housing member is made of resin material, and includes: a basal part with one main face to come into contact with the other of the body and the door; and an arch part protruding from other main face of the basal part that is opposite to the one main face, the basal part and the arch part being integrally formed. The second housing member is made of resin material, accommodates the sliding guide and the elastic member, and is fixedly attached to the first housing member through insertion into a hollow defined between the basal part and the arch part of the first housing member.

### BRIEF DESCRIPTION OF DRAWINGS

FIG. 1 is a perspective view illustrating an overall configuration of a vehicle door checker according to a first embodiment of the present invention.

FIG. 2 is an exploded perspective view illustrating a configuration of the vehicle door checker.

FIG. 3 is an exploded perspective view illustrating a configuration of a housing in the vehicle door checker.

FIG. 4 is a perspective view illustrating a configuration of a housing unit constituting the housing.

FIG. 5 is a cross-sectional view illustrating a fitting state of a wedge part of the housing unit in a recess of a housing base.

FIG. 6 is a perspective view (with a partial cross-sectional view) illustrating a structure to fixedly attach a bolt to a basal part of the housing base.

FIG. 7A is a perspective view illustrating a configuration of the housing base.

FIG. 7B is a perspective view illustrating a state where a stopper of a check plate is in contact with a ceiling wall of the housing base.

FIG. 8A is a perspective view illustrating a configuration of a housing base included in a vehicle door checker according to a second embodiment of the present invention.

FIG. 8B is a perspective view illustrating a configuration of a housing unit included in the vehicle door checker according to the second embodiment.

FIG. 9A is a perspective view illustrating a housing base included in a vehicle door checker according to a third embodiment of the present invention and obliquely seen in a certain direction.

FIG. 9B is a perspective view illustrating the housing base included in the vehicle door checker according to the third embodiment of the present invention and obliquely seen in another direction.

FIG. 10A is a perspective view illustrating a configuration of a housing unit included in a vehicle door checker according to a fourth embodiment of the present invention.

FIG. 10B is a perspective view illustrating a configuration of a housing base included in the vehicle door checker according to the fourth embodiment.

FIG. 11A is a perspective view illustrating a configuration of a housing unit included in a vehicle door checker according to a fifth embodiment of the present invention.

FIG. 11B is a schematic view illustrating a state where the housing unit is attached to a housing base in the vehicle door checker according to the fifth embodiment.

FIG. 12 is a perspective view illustrating a configuration of a housing base included in a vehicle door checker according to a sixth embodiment of the present invention.

FIG. 13 is a cross-sectional view illustrating a configuration of a housing included in a vehicle door checker according to a seventh embodiment of the present invention.

FIG. 14 is a schematic view illustrating a configuration of a housing base.

FIG. 15 is a schematic view of an elastic member and a sliding guide taken in cross-section along the line XV-XV in FIG. 13.

### DESCRIPTION OF EMBODIMENTS

Hereinafter, embodiments of the present invention will be described with reference to the accompanying drawings. It should be noted that each of the following embodiments illustrates one specific example of the present invention, and the present invention is not limited to each embodiment except its essential configuration.

### First Embodiment

### 1. Configuration of a Vehicle Door Checker 1

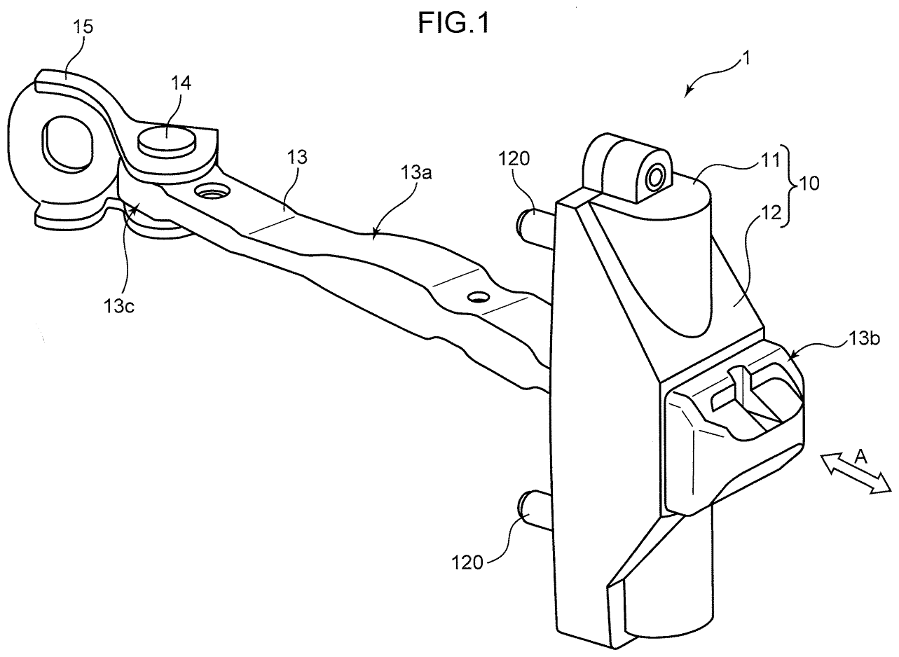

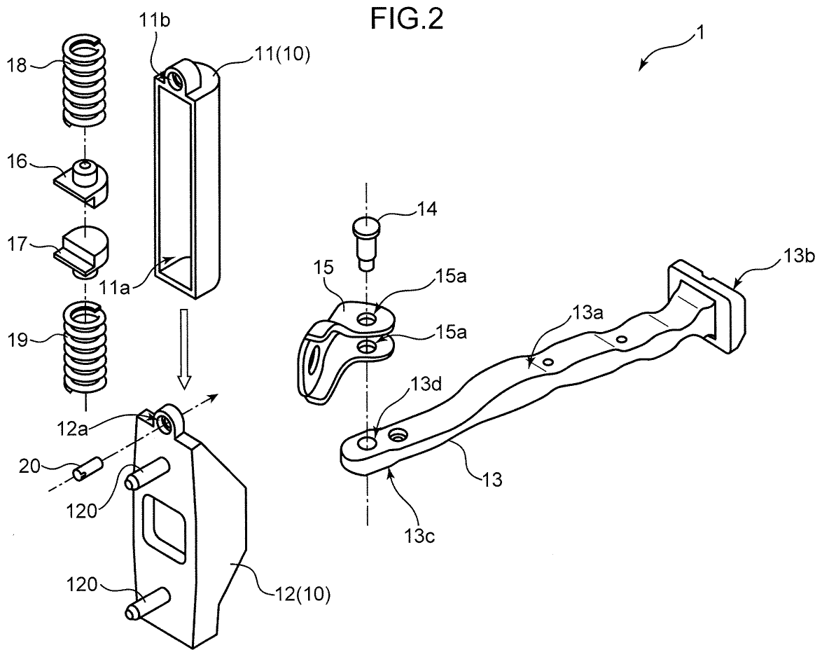

The configuration of the vehicle door checker 1 according to the first embodiment of the present invention will be described with reference to FIG. 1 and FIG. 2 As illustrated in FIG. 1, the vehicle door checker 1 includes a housing 10 and a check plate 13. The housing 10 extends in a direction intersecting a moving direction (direction indicated by an arrow A) of the check plate 13. The housing 10 includes a housing base (first housing member) 12 and a housing unit (second housing member) 11.

As illustrated in FIG. 2, the vehicle door checker 1 further includes a pair of sliding guides 16, 17 and a pair of elastic members 18, 19. The pair of sliding guides 16, 17 and the pair of elastic members 18, 19 are accommodated in an accommodation space 11a of the housing unit 11.

Each of the sliding guides 16, 17 comes into contact with an associated uneven surface 13a of the check plate 13 located between a stopper 13b and one end 13c opposite to the stopper in a longitudinal direction of the check plate. The sliding guide 16, 17 guides the check plate 13 by coming into sliding contact with the uneven surface 13a of the check plate 13 when the check plate 13 moves relative to the housing 10 in the longitudinal direction (in movement indicated by the arrow A in FIG. 1).

Each elastic member 18, 19 is a coil spring as an example in the embodiment, and elastically urges the sliding guide 16, 17 in a direction of the sliding contact with the uneven surface 13a of the check plate 13.

The housing 10 includes the housing base 12 and the housing unit 11 connected to each other by a connecting member 20. The housing base 12 has a hole 12a and the housing unit 11 has a hole 11b. Each of the holes 11b, 12a allows insertion of the connecting member 20 therein.

Each of the housing base 12 and the housing unit 11 is made of resin material. In the embodiment, each of the housing base 12 and the housing unit 11 is made of glass fiber reinforced polyamide or glass fiber reinforced polypropylene each serving as an example of the resin material. In particular, the glass fiber reinforced polypropylene is desirably adopted as a forming material having a relatively small specific gravity.

In the embodiment, a spring pin is adopted as an example for the connecting member 20. Alternatively, a rivet or a screw may be adoptable as the connecting member 20. Another connecting way, such as a snap fitting connecting way or a welding way, may be adoptable to connect the housing base 12 and the housing unit 11 to each other.

Referring back to FIG. 2, a bracket 15 is attached to the end (one end) 13c of the check plate 13 with a pin 14. The check plate 13 has a through hole 13d at the one end 13c, and the bracket 15 has a through hole 15a. The pin 14 penetrates the through holes 13d, 15a. The bracket 15 is attached to one of a body and a door of the vehicle.

As illustrated in FIG. 1 and FIG. 2, the housing base 12 includes two bolts 120. The housing 10 is attached to the other of the body and the door with the bolts 120 of the housing base 12.

### 2. Configuration of the Housing Base 12 and the Housing Unit 11

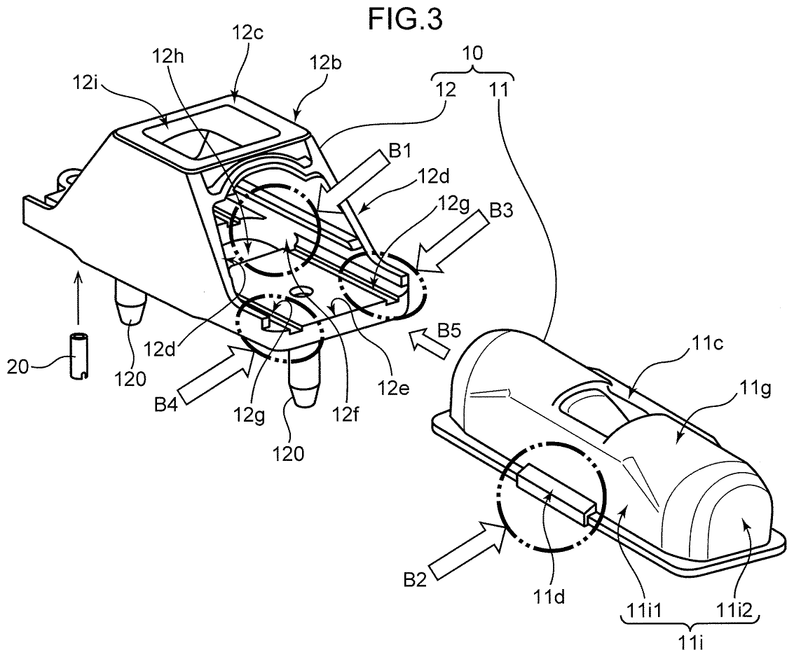

The configuration of the housing base 12 and the housing unit 11 will be described with reference to FIG. 3 to FIG. 5.

As illustrated in FIG. 3, the housing base 12 includes a basal part 12e having a flat plate shape, and an arch part 12b having an arch shape protruding from a face of the basal part 12e that is opposite to another face from which the bolts 120 extend, the basal part 12e and the arch part 12b being integrally formed. The arch part 12b has an arch ceiling wall 12c facing the basal part 12e at a distance therefrom, and two arch side walls 12d connecting the arch ceiling wall 12c and the basal part 12e to each other. The basal part 12e and the arch ceiling wall 12c respectively have insertion windows 12h, 12i to allow insertion of the check plate 13 therein. Each insertion window 12h, 12i is defined to avoid contact with a portion of the check plate 13 having the uneven surface 13a (a portion between the stopper 13b and the one end 13c in the longitudinal direction).

The housing unit 11 has four side walls 11i and one ceiling wall (second member ceiling wall) 11g. The ceiling wall 11g has an insertion window 11c that opens to allow insertion of the portion of the check plate 13 having the uneven surface 13a (the portion between the stopper 13b and the one end 13c in the longitudinal direction). The four side walls 11i include two side walls 11i1 facing each other and two side walls 11i2 facing each other. Among the side walls, each side wall 11i1 faces the associated arch side wall 12d of the housing base 12 when the housing unit 11 is inserted into a hollow defined between the basal part 12e and the arch part 12b of the housing base 12 as indicated by an arrow B5. In other words, each of the two side walls 11i1 of the housing unit 11 corresponds to the “second member side wall”.

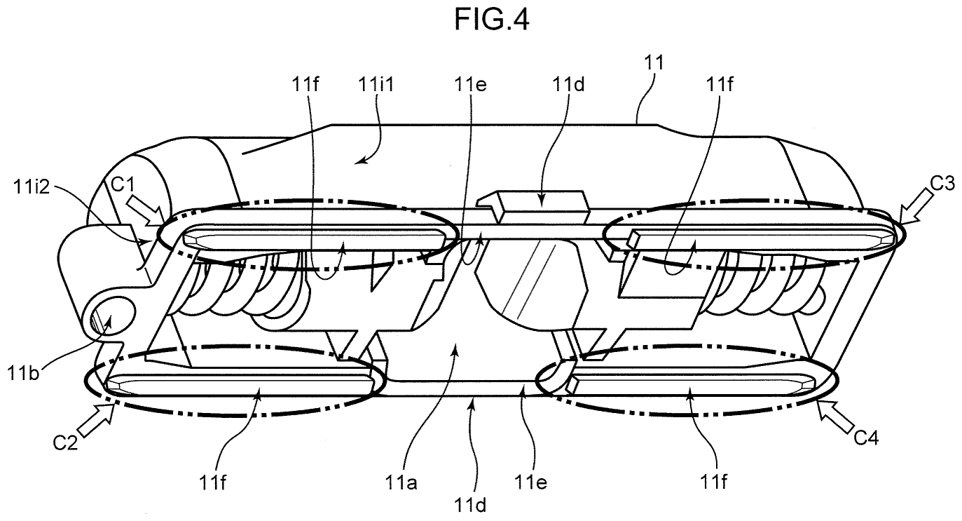

As illustrated in FIG. 4, the housing unit 11 has an opening facing the ceiling wall 11g and serving as an entrance for accommodating the sliding guides 16, 17 and the elastic members 18, 19.

Referring back to FIG. 3, each arch side wall 12d of the housing base 12 has a recess 12f (in a region indicated by an arrow B1) recessed inward in a thickness direction of the arch side wall 12d. Although FIG. 3 illustrates only the recess 12f of one of the arch side walls 12d for convenience, the remaining other arch side wall 12d also has a recess 12f as well.

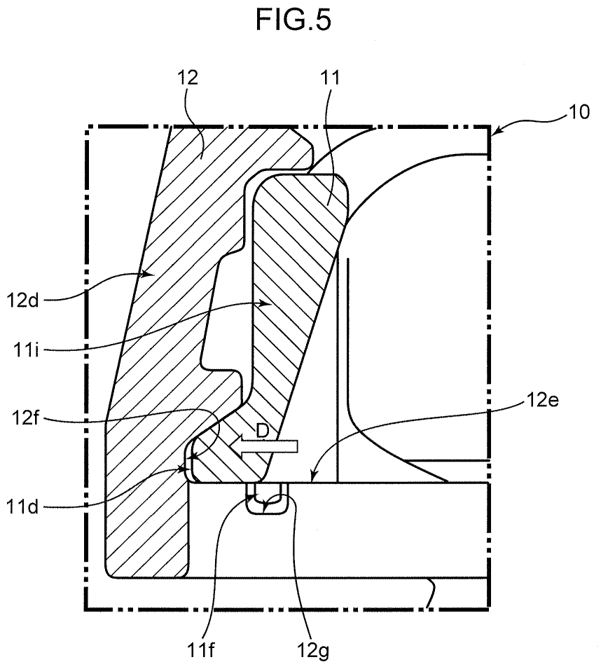

As illustrated in FIG. 3 and FIG. 4, each side wall 11i1 of the housing unit 11 has a wedge part (first wedge part) 11d (in a region indicated by an arrow B2) protruding outward in a facing direction thereof. As illustrated in FIG. 5, the wedge part 11d of the housing unit 11 fits in the recess 12f of the housing base 12 as indicated by an arrow D when the housing unit 11 is inserted in the hollow defined between the basal part 12e and the arch part 12b of the housing base 12.

The arch side walls 12d of the housing base 12 may respectively have wedge parts protruding inward in the facing direction, and the side walls 11i of the housing unit 11 may respectively have recesses to allow the associated wedge parts to fit therein.

Referring back to FIG. 3, the basal part 12e of the housing base 12 has two grooves 12g (in regions indicated by arrows B3, B4) being parallel to each other. The two grooves 12g are spaced from each other in a width direction of the basal part 12e and extend in a longitudinal direction (first direction) of the basal part 12e.

In contrast, as illustrated in FIG. 4, each side wall 11i1 of the housing unit 11 has protrusions 11f (in regions indicated by arrows C1 to C4) extending in an insertion direction for insertion of the housing unit 11 into the hollow. Each protrusion 11f protrudes from a bottom edge section 11e of the side wall 11i1 in a direction opposite to the ceiling wall 11g.

As illustrated in FIG. 4, the protrusions 11f of the housing unit 11 are inserted in the associated grooves 12g of the housing base 12. This allows each wedge part 11d to fit in the associated recess 12f, and thus prevents a distance between the side walls 11i1 from being shorter even in a case where a reaction force (force advancing in a direction opposite to the arrow D) from the side wall 12d of the housing base 12 acts to the side wall 11i1 of the housing unit 11. In other words, this configuration can reliably keep the accommodation space 11a in the housing unit 11 while achieving firmly fixed attachment of the housing unit 11 to the housing base 12.

### 3. Structure to Fix the Bolts 120 to the Basal Part 12e of the Housing Base 12

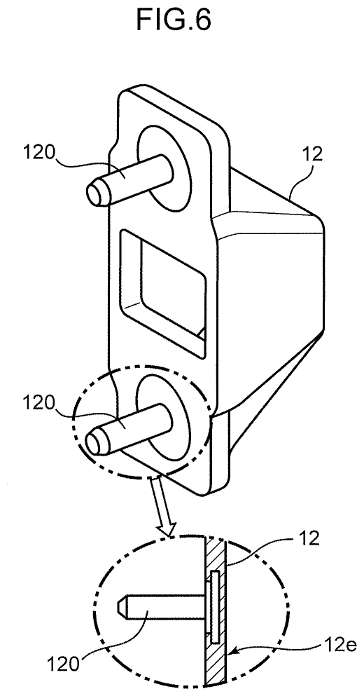

The structure to fix the bolts 120 to the basal part 12e of the housing base 12 will be described with reference to FIG. 6.

As illustrated in FIG. 6, the two bolts (fasteners) 120 are fixed to the basal part 12e of the housing base 12 made of resin material through insertion molding.

### 4. Advantageous Effects

In the vehicle door checker 1 according to the embodiment, the housing base 12 and the housing unit 11, both made of resin material, constitute the housing 10 in combination. This configuration achieves a lighter weight than the weight of the door checker disclosed in Patent Literature 1 in which the casing and the casing cover, both made of metal, constitute the housing.

In the vehicle door checker 1, each of the housing base 12 and the housing unit 11 is made of resin material. Hence, in the vehicle door checker 1, even if a coil spring made of metal for each elastic member 18, 19 is used, noise attributed to contact between metals will never occur between the elastic member 18, 19 and either or both of the housing base 12 and the housing unit 11 at extension of the elastic member 18, 19. The vehicle door checker 1 thus can have high quality while avoiding occurrence of such noise attributed to contact between metals at extension of each elastic member even without filling an inner part of the housing with grease or other filler.

In the vehicle door checker 1, the housing base 12 and the housing unit 11 are connected to each other through insertion of the housing unit 11 into the hollow defined between the basal part 12e and the arch part 12b of the housing base 12. Because of this, the vehicle door checker 1 is capable of adopting various sizes of the housing unit 11 having an acceptable range for the insertion into the hollow of the housing base 12. Accordingly, in the vehicle door checker 1, replacement or reassembling of only the housing unit 11 is satisfactory even for different types of elastic members 18, 19 and the sliding guides 16, 17 while the housing base 12 is kept used.

In the vehicle door checker 1 according to the embodiment, the housing 10 further includes the connecting member 20 that connects the housing base 12 and the housing unit 11 to each other. The vehicle door checker 1 hence achieves further firmly fixed attachment of the housing unit 11 to the housing base 12. The vehicle door checker 1 achieves prevention of rattling of the housing unit 11 relative to the housing base 12 by the movement of the sliding guides 16, 17 in the accommodation space 11a of the housing unit 11 or vibration at running of the vehicle.

In the vehicle door checker 1 according to the embodiment, each side wall 11i1 of the housing unit 11 has the wedge part (first wedge part) 11d and each arch side wall 12d of the housing base 12 has the recess 12f. As for the vehicle door checker 1 having this configuration, the wedge part 11d fits in the associated recess 12f at assembling (connecting) the housing unit 11 to the housing base 12 (see FIG. 5). In this manner, the vehicle door checker 1 enables fixed attachment of the housing unit 11 to the housing base 12 without rattling.

In the vehicle door checker 1 according to the embodiment, the side wall (second member side wall) 11i1 of the housing unit 11 has the protrusions 11f, and the basal part 12e of the housing base 12 has the grooves 12g. The vehicle door checker 1 having this configuration prevents the distance between the side walls 11i1 from becoming short by fitting of the wedge part 11d in the recess 12f. Specifically, each wedge part 11d fits in the associated recess 12f, and a reaction force acts inward (opposite to the arrow D in FIG. 5) to the side wall 11i1 in an opposing direction thereof. However, the protrusions 11f are inserted in the grooves 12g. This prevents the side wall 11i1 from deforming or moving inward in the opposing direction. The vehicle door checker 1 thus can avoid contact of the elastic members 18, 19 and the sliding guides 16, 17 with the housing 10 by preventing the space (the accommodation space 11a of the housing unit 11) in the housing 10 from being narrower while achieving fixed attachment of the housing unit 11 to the housing base 12 without rattling.

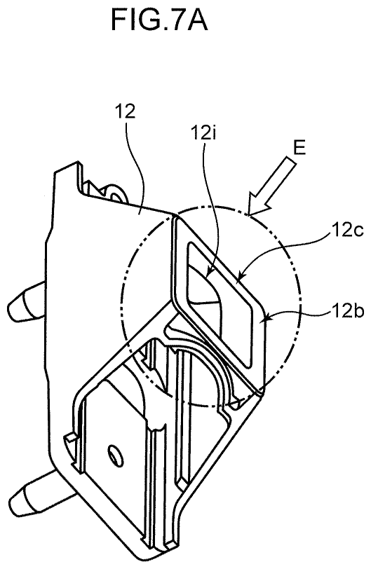

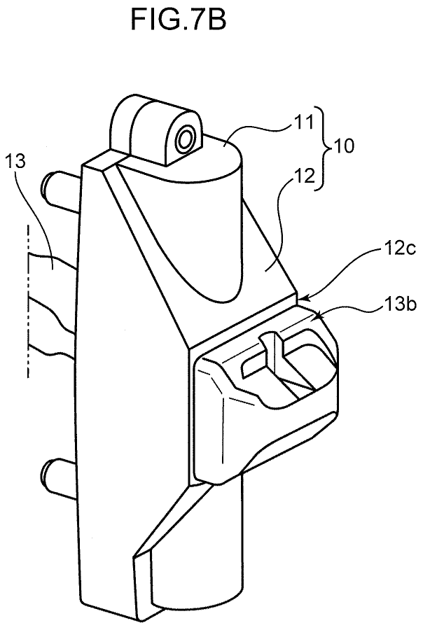

In the vehicle door checker 1 according to the embodiment, as illustrated in FIG. 7A and FIG. 7B, an edge portion (in a region indicated by an arrow E) around the insertion window 12i at the arch ceiling wall 12c of the housing base 12 comes into contact with the stopper 13b of the check plate 13. The vehicle door checker 1 having this configuration allows the housing base 12 firmly fixed in the aforementioned manner to receive a shock load of the stopper 13b. This configuration achieves a reduction in deformation or damage to the housing unit 11.

Here, the door checker disclosed in Patent Literature 1 has a structure in which the casing cover whose main surface has an edge portion being in contact with end faces of four side walls of the casing receives the shock load of the stopper. The shock load from the stopper is propagated to the end faces of the four side walls of the casing. As a result, each end face and the edge portion of the casing cover being in contact with the end face may deform or be damaged.

In contrast, in the vehicle door checker 1, the arch part 12b of the housing base 12 receives a shock load of the stopper 13b. The vehicle door checker 1 having this configuration can avoid deformation or damage to the housing unit 11 even when the door is fully opened.

In the vehicle door checker 1 according to the embodiment, the housing base 12 includes the bolts 120 each resulting from insertion molding. As for the vehicle door checker 1, adoption of such a bolt 120 as given anti-rust treatment in advance succeeds in avoiding an increase in the number of processing steps and deterioration in productivity at manufacturing the vehicle door checker, and reducing the manufacturing cost. Conversely, as for the conventional door checker, the bolt is required to be fixed to the casing made of metal by welding. The conventional case needs anti-rust treatment after the welding to prevent a reduction in the welding quality, which may lead to an increase in the number of processing steps and deterioration in the productivity.

In contrast, as for the vehicle door checker according to the embodiment, the bolts 120 are fixed to the basal part 12e through the insertion molding. Adoption of the bolts 120 given the anti-rust treatment in advance eliminates the need for additional anti-trust treatment to the bolt 120 or the peripheral area thereof in a manufacturing process for the vehicle door checker. The vehicle door checker according to the embodiment thus can avoid an increase in the number of processing steps and deterioration in the productivity, and achieves a reduction in the manufacturing cost.

Although each bolt 120 is integrally formed with the basal part 12e of the housing base 12 through the insertion molding in the embodiment, the present invention may adopt another way of attaching each bolt 120 to the basal part 12e without limitation to the insertion molding. For instance, press fitting may be adoptable.

Conclusively, the vehicle door checker 1 according to the embodiment achieves weight reduction and high quality.

### Second Embodiment

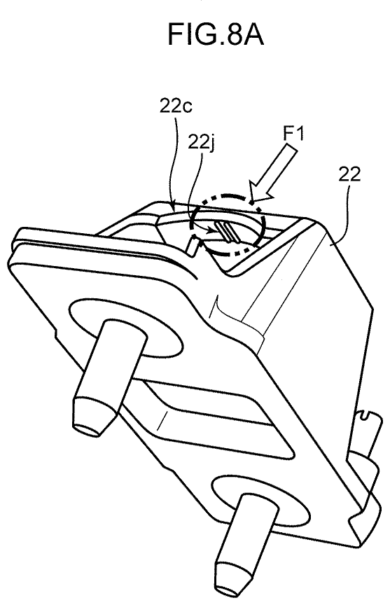

A configuration of a vehicle door checker according to the second embodiment of the present invention will be described with reference to FIG. 8A and FIG. 8B. The vehicle door checker according to the embodiment has features in a housing base (first housing member) 22 and a housing unit (second housing member) 21, and has the same configuration as the configuration of the vehicle door checker 1 according to the first embodiment except for those features. In this respect, each of FIG. 8A and FIG. 8B illustrates only the housing base 22 and the housing unit 21. Hereinafter, duplicative explanation for the same configuration as the configuration of the vehicle door checker 1 according to the first embodiment will be omitted.

As illustrated in FIG. 8A, the housing base 22 includes an arch part having an arch ceiling wall 22c that has a plurality of press-fit ribs (first member ribs) 22j (in a region indicated by an arrow F1) extending in an insertion direction (first direction) in which the housing unit 21 is inserted.

As illustrated in FIG. 8B, the housing unit 21 has a ceiling wall (second member ceiling wall) 21g having, in a periphery of an insertion window 21c, a plurality of press-fit ribs (second member ribs) 21h (in a region indicated by an arrow F2) extending in an insertion direction (first direction) for insertion of the housing unit 21 into a hollow of the housing base 22.

Each of the press-fit ribs 22j of the housing base 22 and the press-fit ribs 21h of the housing unit 21 has at least a portion (at least a leading end in a protruding direction) crushed through insertion of the housing unit 21 into a hollow of the housing base 22.

The vehicle door checker according to the embodiment has the same configuration as the configuration of the vehicle door checker 1 according to the first embodiment except that the housing base 22 and the housing unit 21 respectively include the press-fit ribs 22j, 21h, and thus can provide the same advantageous effects as the vehicle door checker according to the first embodiment.

In the vehicle door checker according to the embodiment, the arch ceiling wall 22c of the housing base 22 and the ceiling wall (second member ceiling wall) 21g of the housing unit 21 respectively have the press-fit ribs 22j, 21h. At least a portion of each of the press-fit ribs 22j, 21h is crushed through insertion of the housing unit 21 into a hollow, and a reaction force attributed to the crushing of the press-fit ribs 22j, 21h acts between the housing base 22 and the housing unit 21. The vehicle door checker according to the modification therefore achieves further firmly fixed attachment of the housing unit 21 to the housing base 22, and more reliably achieves prevention of rattling between the housing unit and the housing base.

### Third Embodiment

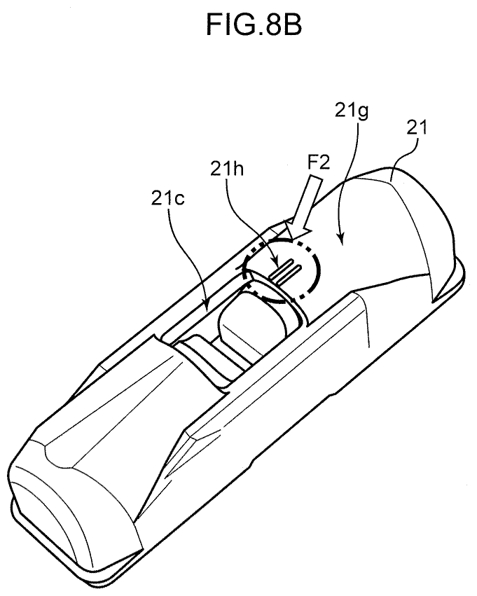

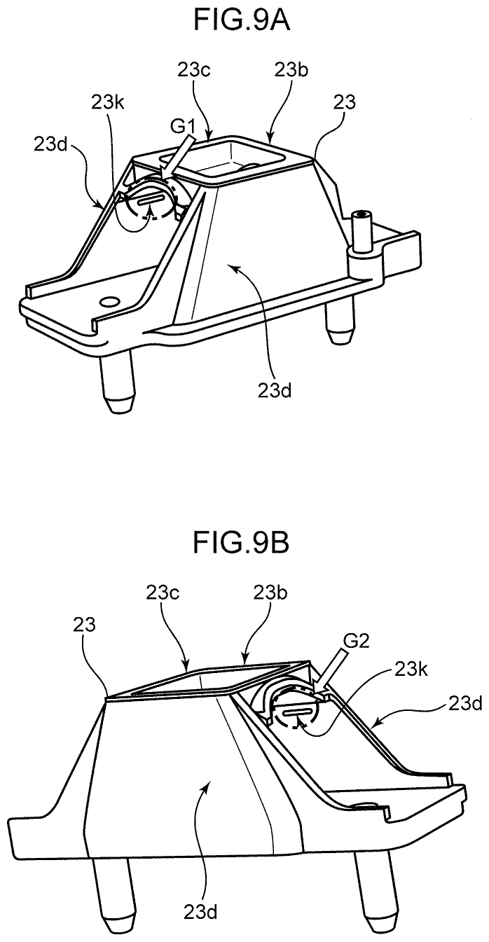

A configuration of a vehicle door checker according to the third embodiment of the present invention will be described with reference to FIG. 9A and FIG. 9B. The vehicle door checker according to the embodiment has features in a housing base (first housing member) 23, and has the same configuration as the configuration of the vehicle door checker 1 according to the first embodiment except for those features. In this respect, each of FIG. 9A and FIG. 9B illustrates only the housing base 22. Hereinafter, duplicative explanation for the same configuration as the configuration of the vehicle door checker 1 according to the first embodiment will be omitted.

As illustrated in FIGS. 9A and 9B, the housing base 23 includes an arch part 23b that has opposite arch side walls 23d each having a press-fit rib (second member rib) 23k (in each region indicated by an arrow G1, G2) extending in an insertion direction (first direction) in which the housing unit 11 is inserted. The press-fit ribs 23k protrude from respective inner faces of the side walls 23d (respective inner faces of the side walls 23d in a facing direction). The press-fit ribs 23k are parallel to each other in respective portions of the side walls 23d near the ceiling wall 23c.

As for the vehicle door checker according to the embodiment, at least a portion (at least a leading end in the protruding direction) of each press-fit rib 23k of the housing base 23 is crushed through insertion of the housing unit 11 into the hollow of the housing base 23.

The vehicle door checker according to the embodiment has the same configuration as the configuration of the vehicle door checker 1 according to the first embodiment except that the housing base 23 includes the press-fit ribs 23k, and thus can provide the same advantageous effects as the vehicle door checker according to the first embodiment.

In the vehicle door checker according to the embodiment, each side wall 23d of the housing base 23 has the press-fit ribs 23k, at least a portion of the press-fit ribs 23k being crushed through the insertion of the housing unit 11 into a hollow of the housing base 23. In the vehicle door checker according to the embodiment having this configuration, a reaction force attributed to the crushing of the press-fit ribs 23k acts between the housing base 23 and the housing unit 11. The vehicle door checker according to the embodiment therefore achieves further firmly fixed attachment of the housing unit 11 to the housing base 23, and more reliably achieves prevention of rattling between the housing unit and the housing base in the same manner as the second embodiment.

Although each side wall 23d of the housing base 23 has the press-fit ribs 23k, the press-fit ribs 22j of the housing base 22 and the press-fit ribs 21h of the housing unit 21 in the second embodiment are adoptable in combination.

### Fourth Embodiment

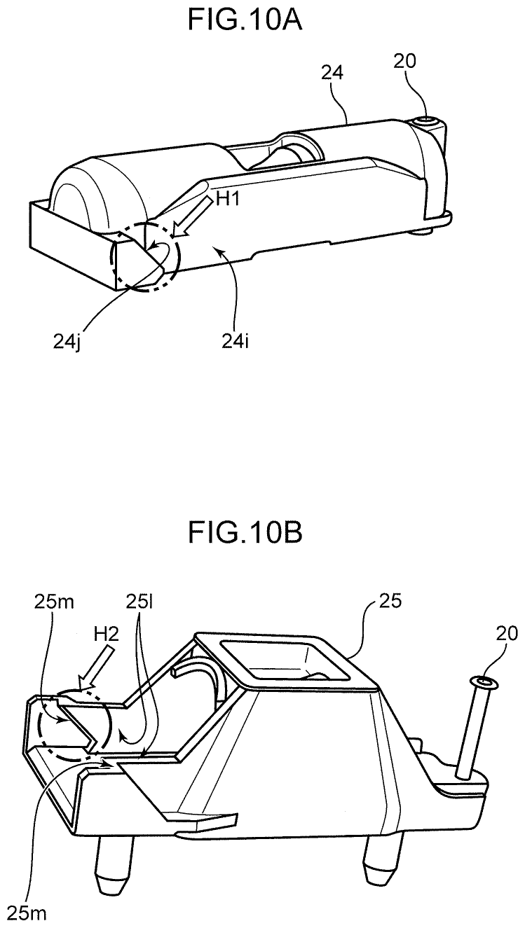

A configuration of a vehicle door checker according to the fourth embodiment of the present invention will be described with reference to FIG. 10A and FIG. 10B. The vehicle door checker according to the embodiment has features in a housing unit (second housing member) 24 and a housing base (first housing member) 25, and has the same configuration as the configuration of the vehicle door checker 1 according to the first embodiment except for those features. In this respect, FIG. 10A illustrates the housing unit 24 and FIG. 10B illustrates the housing base 25. Hereinafter, duplicative explanation for the same configuration as the configuration of the vehicle door checker 1 according to the first embodiment will be omitted.

As illustrated in FIG. 10A and FIG. 10B, the housing unit 24 and the housing base 25 are connected to each other by a connecting member 20 at respective one ends of the housing unit and the housing base in a longitudinal direction (first direction) thereof. As illustrated in FIG. 10A, the housing unit 24 has side walls 24i extending in the longitudinal direction, each side wall having a wedge part (third wedge part) 24j at other end (in a region indicated by an arrow H1) opposite to the one end in the longitudinal direction. The wedge part 24j of the housing unit 24 has a slope to be gradually away from a main face (i.e., a main face from which an arch part protrudes) of a basal part of the housing base 25 as advancing from the one end toward the other end in the first direction.

As illustrated in FIG. 10B, the housing base 25 has an end side wall 251 being continuous to a side wall of the arch part at the other end opposite to the one end in the longitudinal direction. The end side wall 251 of the housing base 25 has a wedge part (second wedge part) 25m (in a region indicated by an arrow H2). The wedge part 25m of the housing base 25 has a slope to come into contact with the slope of the wedge part 24j of the housing unit 24 at fixed attachment of the housing unit 24 to the housing base 25.

The slope of the wedge part 24j of the housing unit 24 and the slope of the wedge part 25m of the housing base 25 come into contact with each other without a gap therebetween when the housing unit 24 is connected to the housing base 25 by the connecting member 20.

The vehicle door checker according to the embodiment has the same configuration as the configuration of the vehicle door checker 1 according to the first embodiment except that the housing unit 24 has the wedge part 24j and the housing base 25 has the wedge part 25m, and thus can provide the same advantageous effects as the vehicle door checker according to the first embodiment.

As for the vehicle door checker according to the embodiment, the slope of the wedge part 24j and the slope of the wedge part 25m come into contact with each other without a gap therebetween when the housing unit 24 is connected to the housing base 25. Thus, the housing unit 24 is further firmly fixed to the housing base 25.

### Fifth Embodiment

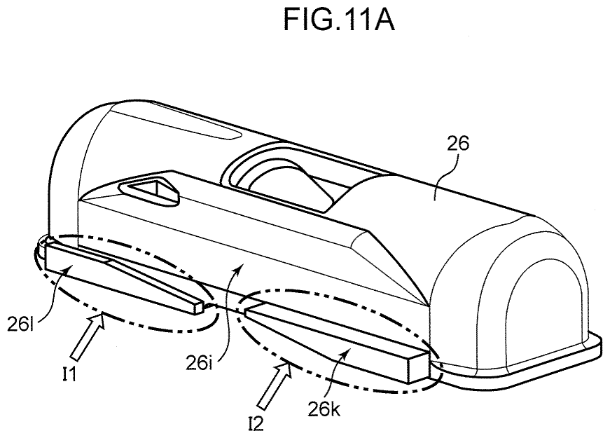

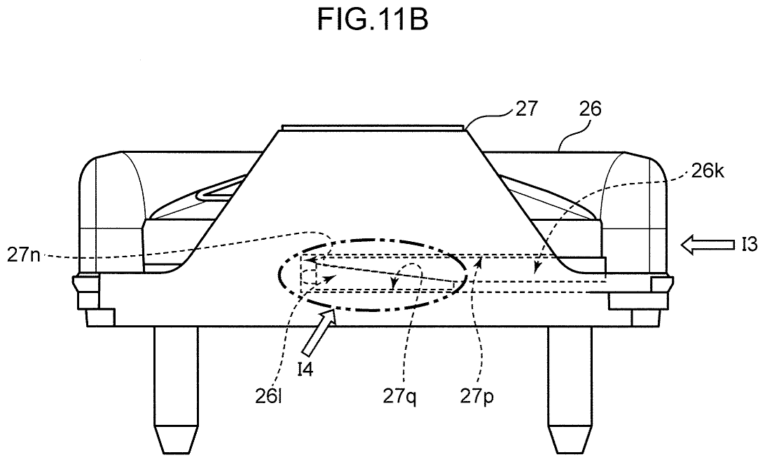

A configuration of a vehicle door checker according to the fifth embodiment of the present invention will be described with reference to FIG. 11A and FIG. 11B. The vehicle door checker according to the embodiment has features in a housing unit (second housing member) 26 and a housing base (first housing member) 27, and has the same configuration as the configuration of the vehicle door checker 1 according to the first embodiment except for those features. In this respect, FIG. 11A and FIG. 11B illustrate only the housing unit 26 and the housing base 27. Hereinafter, duplicative explanation for the same configuration as the configuration of the vehicle door checker 1 according to the first embodiment will be omitted.

FIG. 11A illustrates the housing unit 26 to be connected to the housing base 27, and FIG. 11B illustrates a state where the housing unit 26 has been connected to the housing base 27.

As illustrated in FIG. 11A, the housing unit 26 has a side wall (second member side wall) 26i having a wedge part (fourth wedge part) 26k and a wedge part (fifth wedge part) 26l (in regions respectively indicated by arrows I2, I1) in a state before the housing unit 26 is inserted into a hollow of the housing base 27. The wedge part 26k and the wedge part 26l are spaced from each other in an insertion direction (first direction) for insertion of the housing unit 26 into the hollow, and respectively have slopes to face each other.

As illustrated in FIG. 11B, the housing base 27 has an end wall (pressing force applying part) 27n configured to apply a pressing force to the wedge part 26l at fixed attachment of the housing unit 26 to the housing base 27. The housing base 27 has facing walls 27p, 27q to be connected to the end wall 27n and face each other.

The housing unit 26 is inserted into the housing base 27 as indicated by an arrow I3 for the fixed attachment of the housing unit 26 to the housing base 27. At the inserting, the wedge part 26k and the wedge part 26l of the housing unit 26 advance in a gap between the facing wall 27p and the facing wall 27q. The wedge part 26l hits the end wall 27n when the housing unit 26 is inserted into the housing base 27 at a predetermined distance. Further insertion of the housing unit 26 makes the wedge part 26l leave the side wall 26i of the housing unit 26 with the pressing force from the end wall 27n.

Still further insertion of the housing unit 26 makes a portion of the wedge part 26l having left the side wall 26i come under the wedge part 26k (in a region indicated by an arrow I3). In this manner, the wedge part 26k and the wedge part 26l try to push the facing walls 27p,27q outward in opposite directions. Accordingly, in the vehicle door checker according to the modification, the housing base 27 and the housing unit 26 are pressed in contact with each other by the contact between the wedge part 26k and the wedge part 26l, the contact between the wedge part 26k and the facing wall 27p, and the contact between the wedge part 26l and the facing wall 27q.

The vehicle door checker according to the embodiment has the same configuration as the configuration of the vehicle door checker 1 according to the first embodiment except that the housing unit 26 includes the wedge parts 26k, 26l and the housing base 27 has the end wall 27n and the facing walls 27p, 27q, and thus can provide the same advantageous effects as the vehicle door checker according to the first embodiment.

### Sixth Embodiment

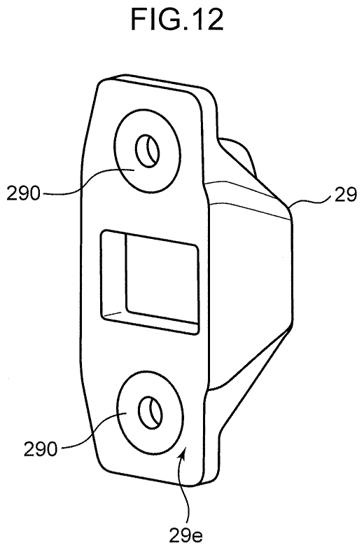

A configuration of a vehicle door checker according to the sixth embodiment of the present invention will be described with reference to FIG. 12. The vehicle door checker according to the embodiment has features in a housing base (first housing member) 29, and has the same configuration as the configuration of the vehicle door checker 1 according to the first embodiment except for those features. In this respect, FIG. 12 illustrates only the housing base 29. Hereinafter, duplicative explanation for the same configuration as the configuration of the vehicle door checker 1 according to the first embodiment will be omitted.

As illustrated in FIG. 12, the housing base 29 is made of resin material, and includes two nuts (fasteners) 290 fixed to a basal part through insertion molding in the embodiment.

The vehicle door checker according to the embodiment has the same configuration as the configuration of the vehicle door checker 1 according to the first embodiment except the feature that the housing base 29 includes the nuts 290 fixed through the insertion molding, and thus can provide the same advantageous effects as the vehicle door checker according to the first embodiment.

As for the vehicle door checker according to the embodiment, adoption of such nuts 290 as given the anti-rust treatment in advance to fix the nuts 290 to the basal part of the housing base 29 succeeds in avoiding an increase in the number of processing steps and deterioration in productivity at manufacturing the vehicle door checker, and reducing in the manufacturing cost.

Although the nuts 290 are integrally formed with the basal part of the housing base 29 through insertion molding in the embodiment, a way of attaching the nuts 290 to the basal part is not limited to this way in the present invention. Another way, for example, a press-fitting way may be adoptable.

### Seventh Embodiment

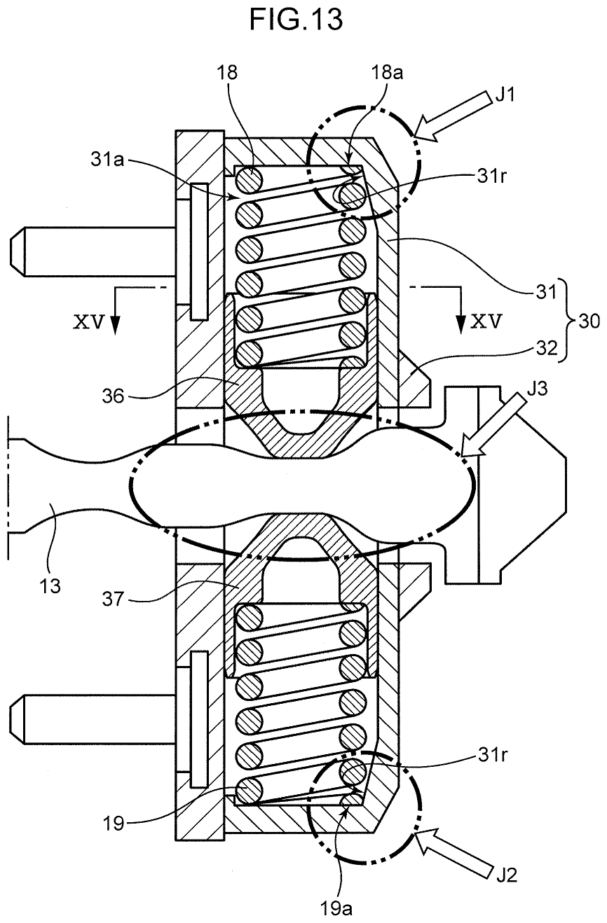

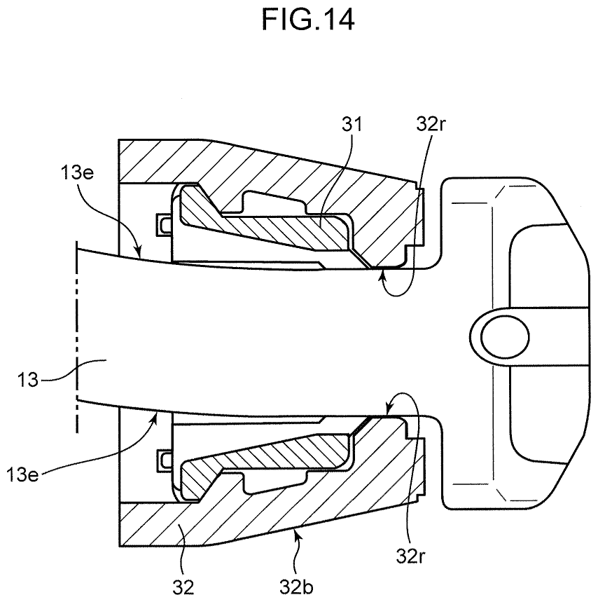

A configuration of a vehicle door checker according to the seventh embodiment of the present invention will be described with reference to FIG. 13 to FIG. 15. The vehicle door checker according to the embodiment has features in a housing 30 and sliding guides 36, 37, and has the same configuration as the configuration of the vehicle door checker 1 according to the first embodiment except for those features. Hereinafter, duplicative explanation for the same configuration as the configuration of the vehicle door checker 1 according to the first embodiment will be omitted.

As illustrated in FIG. 13, the vehicle door checker according to the embodiment includes the housing 30, a check plate 13, the sliding guides 36, 37, and elastic members 18, 19. The housing 30 includes a housing base (first housing member) 32 and a housing unit (second housing member) 31 in combination. In the embodiment, each of the housing base 32 and the housing unit 31 is made of resin material (e.g., glass fiber reinforced polyamide, glass fiber reinforced polypropylene, or other resin material). The housing base 32 has the same shape as the housing base 12 in the first embodiment.

The housing unit 31 differs from the housing unit 11 in the first embodiment in a part of a structure of its inner wall surface. Specifically, a portion and a peripheral area thereof the inner wall surface being in contact with an end coil 18a, 19a of the elastic member 18, 19 (coil spring) that is opposite to a surface in contact with the sliding guide 36, 37 serves as an end coil position restrictor 31r that restricts a position of the end coil 18a, 19a (in each region indicated by an arrow J1, J2). The end coil position restrictor 31r has an inner diameter smaller than a diameter of other portions.

The vehicle door checker according to the embodiment in which the housing unit 31 includes the end coil position restrictor 31r can prevent the elastic member (coil spring) 18, 19 from tilting in the housing 30. The vehicle door checker having this configuration hence prevents the elastic member 18, 19 from coming into contact with the housing base 32 or the housing unit 31 due to such tilting, and thus can more reliably avoid occurrence of interference noise.

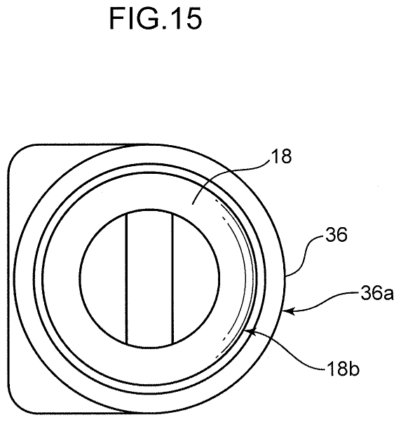

Next, a correlation between the check plate 13 and the housing base 32 (in a region indicated by an arrow J3 in FIG. 13) will be described with reference to FIG. 14 in a view in a direction (perpendicularly) intersecting a direction in which the sliding guide 36, 37 comes into contact with the check plate 13 and a longitudinal direction of the check plate 13.

As illustrated in FIG. 14, in the vehicle door checker according to the embodiment, the housing base 32 includes an arch part 32b having a check plate side surface restrictor 32r being in contact with or adjacent to a side surface 13e of a detent portion having an uneven surface 13a of the check plate 13. Here, two check plate side surface restrictors 32r are arranged respectively at two positions to face each other and sandwich both side surfaces 13e of the check plate 13 therebetween.

The vehicle door checker according to the embodiment in which the housing base 32 includes each check plate side surface restrictor 32r can restrict vibration of the check plate 13 (vibration in a direction intersecting both the longitudinal direction of the check plate 13 and the direction in which the sliding guide 36, 37 comes into contact with the check plate 13, i.e. the width direction of the check plate 13). Besides, the vehicle door checker according to the embodiment in which the housing base 32 includes the check plate side surface restrictor 32r as described above can have a smaller size than a size of a vehicle door checker including a sliding guide having guide parts to sandwich a check plate therebetween from both sides.

Although the housing base 32 includes the check plate side surface restrictor 32r in the embodiment, the housing unit 31 may include a check plate side surface restrictor instead. This configuration also can exert the same advantageous effects.

Subsequently, the shape of the sliding guide 36, 37 will be described with reference to FIG. 15. Although FIG. 15 illustrates only the sliding guide 36, the sliding guide 37 has the same shape.

In the embodiment, a coil spring is adoptable for the elastic member 18, 19. Hence, as illustrated in FIG. 15, the elastic member 18 has an outer circumference 18b forming a circular shape in a plan view of the elastic member 18 in an axial direction.

The sliding guide 36 has an outer periphery forming a rectangle that is closer to a basal part of the housing base 32, and an outer circumference (unit circumference) 36a forming an arc that is opposite to the basal part of the housing base 32.

In the vehicle door checker according to the embodiment, the unit circumference 36a of the sliding guide 36, 37 forms an arc. The vehicle door checker according to the embodiment having this configuration allows an associated portion of the housing unit 31 surrounding a portion of the sliding guide 36, 37 forming an arc to form an arc. This results in avoiding a size increase in the vehicle door checker.

Although the housing unit 31 includes the end coil position restrictor 31r and the check plate side surface restrictor 32r, and the sliding guide 36, 37 has the unit circumference 36a forming an arc in the vehicle door checker according to the embodiment, the present invention may have at least one of these features. This configuration also can exert the same advantageous effects.

Besides, the vehicle door checker according to the embodiment can exert the same advantageous effects as the vehicle door checker 1 according to the first embodiment.

Modifications Although the coil spring is adopted for the elastic member 18,19 as an example in the first embodiment to the seventh embodiment, a kind of the elastic member is not limited to the coil spring in the present invention. For instance, an elastic member made of rubber may be adoptable.

Although a spring pin is adopted for the connecting member 20 as an example in the first embodiment to the seventh embodiment, a kind of the connecting member is not limited to the spring pin in the present invention. For instance, a rivet (including a blind rivet) or a bolt may be adoptable for the connecting member. In addition, the connecting member is not an indispensable element in the present invention.

In the first embodiment to the seventh embodiment, for example, the check plate 13 may be a solid component that includes: a core part made of metal such as iron; and a resin material such as polyamide covering the surface of the core part. However, the present invention is not limited thereto. For instance, a check plate including a plurality of long plate layers laminated, or a check plate having holes for a weight reduction may be adoptable.

Further, the present invention may appropriately combine the configurations of the first embodiment to the seventh embodiment.

### Conclusion

A vehicle door checker according to an aspect of the present invention is a vehicle door checker to be assembled between a body and a door of a vehicle, and includes a check plate, a housing, a sliding guide, and an elastic member. The check plate is a long link member having one end to be attached to one of the body and the door, and having at least one main surface being an uneven surface. The housing is configured to allow insertion of the check plate therein and to be attached to the other of the body and the door. The sliding guide is configured to guide the check plate by coming into sliding contact with the at least one main surface when the check plate moves relative to the housing in a longitudinal direction of the check plate. The elastic member elastically urges the sliding guide in a direction in which the sliding guide comes into contact with the check plate.

In the vehicle door checker in the aspect, the housing includes a first housing member and a second housing member. The first housing member is made of a resin material, and includes: a basal part with one main face to come into contact with the other of the body and the door; and an arch part protruding from other main face of the basal part that is opposite to the one main face, the basal part and the arch part being integrally formed. The second housing member is made of a resin material, accommodates the sliding guide and the elastic member, and is fixedly attached to the first housing member through insertion into a hollow defined between the basal part and the arch part of the first housing member.

In the vehicle door checker according to the aspect, the first housing member and the second housing member both made of resin material constitute the housing in combination. This configuration achieves a lighter weight than the weight of the door checker disclosed in Patent Literature 1 in which the casing and the casing cover both made of metal constitute the housing.

In the vehicle door checker according to the aspect, each of the first housing member and the second housing member is made of resin material. Hence, in the vehicle door checker according to the aspect, even if a coil spring made of metal for the elastic member is used, noise attributed to contact between metal parts will never occur between the coil spring and either or both of the first housing member and the second housing member at extension of the coil spring. The vehicle door checker according to the aspect thus can be of high quality while avoiding occurrence of noise attributed to contact between metals at extension of the elastic member even without filling an inner part of the housing with grease or other filler.

In the vehicle door checker according to the aspect, the first housing member and the second housing member are combined together through insertion of the second housing member into the hollow defined between the basal part and the arch part of the first housing member. Because of this, the vehicle door checker having this configuration is capable of adopting various sizes of the second housing member having an acceptable range for the insertion into the hollow of the first housing member. Accordingly, in the vehicle door checker according to the aspect, replacement or reassembling of only the second housing member is satisfactory even for different types of elastic members and sliding guides.

In the vehicle door checker according to the aspect, the arch part of the first housing member may have an arch ceiling wall facing the other main face of the basal part, and two arch side walls respectively connecting opposite side ends of the arch ceiling wall and the other main face of the basal part to each other. The second housing member may have two second member side walls respectively facing the two arch side walls at fixed attachment of the first housing member to the second housing member. Further, one of the two arch side walls or one of the two second member side walls may have a first wedge part protruding toward the other side wall, and the other side wall of the two arch side walls or the other side wall of the two second member side walls may have a recess that receives the first wedge part to fit therein.

In the vehicle door checker according to the aspect, one of the two arch side walls of the arch part of the first housing member or one of the two second member side walls of the second housing member has the first wedge part, and the other side wall has the recess. In the vehicle door checker according to the aspect having this configuration, the first wedge part fits in the recess at assembling the second housing member to the first housing member. In this manner, the vehicle door checker according to the aspect achieves further firmly fixed attachment of the second housing member to the first housing member without rattling.

In the vehicle door checker according to the aspect, an insertion direction for insertion of the second housing member into the hollow of the first housing is defined as a first direction, and a direction in which the arch part protruding from the basal part of the first housing member is defined as a second direction. In this case, the first housing member and the second housing member may be connected to each other at respective one ends of the first and second housing members in the first direction. The first housing member may further include, at other end thereof that is opposite to the one end in the first direction, a second wedge part having a first slope to be gradually away from the other main face of the basal part in the second direction as advancing from the one end toward the other end in the first direction. The second housing member may include a third wedge part having a second slope brought into contact with the first slope of the first wedge at fixed attachment to the first housing member.

In the vehicle door checker according to the aspect, the first member has the second wedge part and the second housing member has the third wedge part at their respective other ends (opposite to the one ends thereof where the first housing member and the second housing member are connected to each other) in the first direction (insertion direction for insertion of the housing unit into the hollow). This achieves firmly fixed attachment of the second housing member to the first housing member in the vehicle door checker. In other words, the first housing member and the second housing member are connected to each other at their respective one ends in the first direction, and the first housing member and the second housing member are fixedly attached to each other by contact between their slopes at their respective other ends. In this manner, the vehicle door checker according to the aspect achieves further firmly fixed attachment of the second housing member to the first housing member.

In the vehicle door checker according to the aspect, the arch part of the first housing member may have an arch ceiling wall facing the other main face of the basal part, and two arch side walls respectively connecting opposite side ends of the arch ceiling wall and the other main face of the basal part to each other. The second housing member may have two second member side walls respectively facing the two arch side walls at fixed attachment of the second housing member to the first housing member. Further, an insertion direction for insertion of the second housing member into the hollow of the first housing is defined as a first direction. In this case, each of the two second member side walls of the second housing member may have a fourth wedge part and a fifth wedge part located away from each other in the first direction and respectively having slopes to face each other in the first direction in a state prior to the insertion of the second housing member into the hollow of the first housing member. In this case, the first housing member may have a pressing force applying part configured to apply a pressing force to at least one of the fourth wedge part or the fifth wedge part at the fixed attachment of the second housing member to the first housing member. At least one of the fourth wedge part or the fifth wedge part of the second housing member may be configured to leave the second housing member in response to a pressing force from the pressing force applying part of the first housing member to make the slopes pressed in contact with each other at the fixed attachment of the second housing member to the first housing member.

As for the vehicle door checker according to the aspect, at least one of the fourth wedge part or the fifth wedge part provided at the second housing member in a state prior to the insertion of the second housing member into the hollow is configured to leave the second housing member in response to the pressing force from the pressing force applying part of the first housing member at the insertion to make the slopes of the fourth wedge part and the fifth wedge part be pressed in contact with each other. Consequently, the first housing member and the second housing member are further firmly and fixedly attached to each other by the pressed-contact between the slopes of the fourth wedge part and the fifth wedge part.

In the vehicle door checker according to the aspect, the housing may further include a connecting member that connects the first housing member and the second housing member to each other.

In the vehicle door checker according to the aspect, the housing includes the connecting member that connects the first housing member and the second housing member to each other. This configuration achieves further firmly fixed attachment of the second housing member to the first housing member in the vehicle door checker according to the aspect. The vehicle door checker according to the aspect having this configuration achieves prevention of rattling of the second housing member that may occur relative to the first housing member when the sliding guide operates in the housing.

In the vehicle door checker according to the aspect, an insertion direction for insertion of the second housing member into the hollow of the first housing is defined as a first direction, and a direction in which the arch part protruding from the basal part of the first housing member is defined as a second direction. In this case, the second housing member may have a pair of side walls extending in the first direction and facing each other. Each of the pair of side walls of the second housing member may have a protrusion protruding toward the basal part of the first housing member in the second direction and extending in the first direction. The basal part of the first housing member may have a groove on the other main face of the basal part to receive the protrusion inserted therein.

In the vehicle door checker according to the aspect, each of the pair of side walls of the second housing member has a protrusion, and the basal part of the first housing member has a groove. Thus, the vehicle door checker according to the aspect having this configuration prevents the distance between the pair of side walls of the second housing member from becoming short by fitting of the third wedge part in the recess. Specifically, the third wedge part fits in the recess, and a reaction force acts inward in an opposing direction (intersecting both the first direction and the second direction) with respect to each of the pair of side walls of the second housing member. However, the vehicle door checker according to the aspect in which the protrusion is inserted in the groove prevents each of the pair of side walls from deforming or moving inward in the opposing direction. The vehicle door checker according to the aspect thus can avoid contact of the elastic member and the sliding guide with the second housing member by preventing the accommodation space of the second housing member from being narrower while achieving fixed attachment of the second housing member to the first housing member without rattling.

In the vehicle door checker according to the aspect, the second housing member includes the protrusion, and hence, warpage or deformation which might occur at forming the second housing member can be rectified.

In the vehicle door checker according to the aspect, the second housing member may have a second member ceiling wall facing the other main face of the basal part of the first housing member at the fixed attachment of the second housing member to the first housing member. The arch part of the first housing member may have an arch ceiling wall facing the other main face of the basal part, and may have a first member rib protruding toward at least one of the second member ceiling wall or the second member side wall of the second housing member in the state prior to the insertion of the second housing member into the hollow of the first housing member. The second member ceiling wall of the second housing member may have a second member rib protruding toward the arch ceiling wall of the first housing member in the state prior to the insertion of the second housing member into the hollow of the first housing member. At least a part of each of the first member rib of the first housing member and the second member rib of the second housing member may be crushed through the insertion of the second housing member into the hollow of the first housing member.

As for the vehicle door checker according to the aspect, each of the arch part of the first housing member and the second housing member has a rib (first member rib, second member rib), and at least a part of the rib is configured to be crushed through the insertion of the second housing member into the hollow. Due to this, the vehicle door checker in this aspect having this configuration achieves further firmly fixed attachment of the second housing member to the first housing member, and more reliably achieves prevention of rattling between first and second housing members.

In the vehicle door checker according to the aspect, the arch part of the first housing member may face the other main face of the basal part, and have an arch ceiling wall provided with an insertion window which allows insertion of the check plate therethrough and two arch side walls respectively connecting opposite side ends of the arch ceiling wall and the other main face of the basal part to each other. The check plate may have a stopper at other end of the check plate that is opposite to the one end in the longitudinal direction of the check plate. The arch ceiling wall of the first housing member may have an edge portion surrounding the insertion window to receive the stopper by contact with the stopper at a movement end of the check plate.

In the vehicle door checker according to the aspect, the edge portion at the arch ceiling wall of the first housing member comes into contact with the stopper of the check plate. The vehicle door checker according to the aspect having this configuration allows the first housing member to receive a shock load of the stopper. This configuration achieves a reduction in deformation or damage to the second housing member.

Here, referring to the door checker disclosed in Patent Literature 1, the casing cover and the casing are assembled to each other with the end faces of the four side walls of the casing abutting onto the main surface of the casing cover. In the door checker disclosed in Patent Literature 1, the shock load from the stopper is propagated only onto the end faces of the four side walls of the casing. As a result, each of the four side walls and the contact portion of the main surface of the casing cover with each end face may deform or be damaged.

In contrast, in the vehicle door checker according to the aspect, the arch ceiling wall of the first housing member is configured to receive the shock load from the stopper. The vehicle door checker according to the aspect having this configuration avoids deformation or damage to the second housing member even when the door is fully opened.

In the vehicle door checker according to the aspect, the first housing member may further have a fastener made of a bolt or a nut for attachment to the other of the body and the door, and the fastener may be fixed to the basal part of the first housing.

As for the vehicle door checker according to the aspect, a fastener given the anti-rust treatment in advance is adopted as the fastener (bolt or nut) to be fixed to the basal part of the first housing member. The vehicle door checker according to the aspect having this configuration can avoid an increase in the number of processing steps and deterioration in productivity at manufacturing the vehicle door checker, and achieves a reduction in the manufacturing cost. Conversely, as for the conventional door checker, the bolt is required to be fixed to the casing made of metal by welding. The conventional case needs anti-rust treatment after the welding to prevent a reduction in the welding quality, which may lead to an increase in the number of processing steps and deterioration in the productivity.

In contrast, as for the vehicle door checker according to the aspect, adoption of the fastener given the anti-rust treatment in advance eliminates the need for additional anti-trust treatment to the fastener or the peripheral area thereof in a manufacturing process for the vehicle door checker. The vehicle door checker according to the aspect having this configuration thus can avoid an increase in the number of processing steps and deterioration in the productivity, and achieves a reduction in the manufacturing cost. Examples of an adoptable way of fixedly attaching the fastener to the basal part include insertion molding.

In the vehicle door checker according to the aspect, the elastic member may include a coil spring. The second housing member may further include an end coil position restrictor that restricts positional shift of an end coil of the coil spring, the end coil position restrictor constituting a portion of an inner wall surface of the second housing member that faces a space accommodating the sliding guide and the elastic member.

The vehicle door checker according to the aspect in which the second housing member includes the end coil position restrictor prevents the coil spring from tilting in the accommodation space of the second housing member. The vehicle door checker according to the aspect having this configuration hence prevents the coil spring from coming into contact with the first housing member or the second housing member due to such tilting, and thus can more reliably avoid occurrence of interference noise. Here, referring back to the door checker disclosed in Patent Literature 1, the coil spring is accommodated in the housing including the casing and the casing cover without any restriction on the posture of the coil spring. Therefore, in the door checker disclosed in Patent Literature 1, the coil may tilt in a case where, for example, the coil spring has been too deeply inserted into the casing at the assembling. Such tilting of the coil spring in the housing may bring the coil spring into contact with the inner surface of the housing made of metal, resulting in the occurrence of interference noise.

In contrast, the vehicle door checker according to the aspect including the first housing member and the second housing member both made of resin can avoid occurrence of interference noise accompanied by contact of the coil spring with the inner wall surface of each of the first housing member and the second housing member both made of resin material as well as occurrence of interference noise accompanied by contact between metals.

In the vehicle door checker according to the aspect, at least one of the first housing member or the second housing member may further include a check plate side surface restrictor. The check plate side surface restrictor restricts vibration of the check plate in a direction intersecting the longitudinal direction of the check plate and a direction in which the sliding guide comes into contact with the check plate at the movement of the check plate, the check plate side surface restrictor constituting a portion to come into contact with or being adjacent to a side surface of a portion of the check plate to be inserted in the housing.

In the vehicle door checker according to the aspect, at least one of the first housing member or the second housing member includes the check plate side surface restrictor. The vehicle door checker according to the aspect having this configuration can have a smaller size than a size of a vehicle door checker having guide parts to sandwich a check plate therebetween from opposite sides.

In the vehicle door checker according to the aspect, in a plan view of the sliding guide in a direction in which the sliding guide comes into contact with the one main surface of the check plate, the sliding guide may have an outer edge forming an arc at a position opposite to the basal part of the first housing member.

In the vehicle door checker according to the aspect, the sliding guide has an outer edge forming an arc at the opposite position (that is opposite to a portion closer to the basal part of the first housing member). The vehicle door checker according to the aspect having this configuration allows an associated portion of the second housing member surrounding the portion of the sliding guide forming the arc to form an arc. This results in avoiding a size increase in the vehicle door checker according to the aspect.

Conclusively, the vehicle door checker according to the aspect achieves weight reduction and high quality.

1. A vehicle door checker to be assembled between a body and a door of a vehicle, comprising:
a check plate that is a long link member having one end to be attached to one of the body and the door, and having at least one main surface being an uneven surface;
a housing that is configured to allow insertion of the check plate therein and to be attached to the other of the body and the door;
a sliding guide configured to guide the check plate by coming into sliding contact with the at least one main surface when the check plate moves relative to the housing in a longitudinal direction of the check plate; and
an elastic member that elastically urges the sliding guide in a direction in which the sliding guide comes into contact with the check plate, wherein
the housing includes:
a first housing member made of resin material, and including: a basal part with one main face to come into contact with the other of the body and the door; and an arch part protruding from other main face of the basal part that is opposite to the one main face, the basal part and the arch part being integrally formed; and
a second housing member made of resin material, accommodating the sliding guide and the elastic member, and fixedly attached to the first housing member through insertion into a hollow defined between the basal part and the arch part of the first housing member.

2. The vehicle door checker according to claim 1, wherein the arch part of the first housing member has an arch ceiling wall facing the other main face of the basal part, and two arch side walls respectively connecting opposite side ends of the arch ceiling wall and the other main face of the basal part to each other,
the second housing member has two second member side walls respectively facing the two arch side walls at fixed attachment of the second housing member to the first housing member,
one of the two arch side walls or one of the two second member side walls has a first wedge part protruding toward the other side wall, and
the other side wall of the two arch side walls or the other side wall of the two second member side walls has a recess that receives the first wedge part to fit therein.

3. The vehicle door checker according to claim 1, wherein an insertion direction for insertion of the second housing member into the hollow of the first housing is defined as a first direction, and a direction in which the arch part protruding from the basal part of the first housing member is defined as a second direction,
the first housing member and the second housing member are connected to each other at respective one ends of the first and second housing members in the first direction,
the first housing member includes, at other end thereof that is opposite to the one end in the first direction, a second wedge part having a first slope to be gradually away from the other main face of the basal part in the second direction as advancing from the one end toward the other end in the first direction, and
the second housing member includes a third wedge part having a second slope brought into contact with the first slope of the first wedge part at fixed attachment to the first housing member.

4. The vehicle door checker according to claim 1, wherein the arch part of the first housing member has an arch ceiling wall facing the other main face of the basal part, and two arch side walls respectively connecting opposite side ends of the arch ceiling wall and the other main face of the basal part to each other,
the second housing member has two second member side walls respectively facing the two arch side walls at fixed attachment of the first housing member to the second housing member,
an insertion direction for insertion of the second housing member into the hollow of the first housing is defined as a first direction,
each of the two second member side walls of the second housing member has a fourth wedge part and a fifth wedge part located away from each other in the first direction and respectively having slopes to face each other in the first direction in a state prior to the insertion of the second housing member into the hollow of the first housing,
the first housing member has a pressing force applying part configured to apply a pressing force to at least one of the fourth wedge part or the fifth wedge part at the fixed attachment of the second housing member to the first housing member, and
at least one of the fourth wedge part or the fifth wedge part of the second housing member is configured to leave the second housing member in response to the pressing force from the pressing force applying part of the first housing member to make the slopes pressed in contact with each other at the fixed attachment of the second housing member to the first housing member.

5. The vehicle door checker according to claim 1, wherein the housing further includes a connecting member that connects the first housing member and the second housing member to each other.

6. The vehicle door checker according to claim 1, wherein an insertion direction for insertion of the second housing member into the hollow of the first housing is defined as a first direction, and a direction in which the arch part protruding from the basal part of the first housing member is defined as a second direction,
the second housing member has a pair of side walls extending in the first direction and facing each other,
each of the pair of side walls of the second housing member has a protrusion protruding toward the basal part of the first housing member in the second direction and extending in the first direction, and
the basal part of the first housing member has a groove on the other main face of the basal part to receive the protrusion inserted therein.

7. The vehicle door checker according to claim 1, wherein the second housing member has a second member ceiling wall facing the other main face of the basal part of the first housing member at the fixed attachment of the second housing member to the first housing member,
the arch part of the first housing member has an arch ceiling wall facing the other main face of the basal part, and has a first member rib protruding toward at least one of the second member ceiling wall or the second member side wall of the second housing member in a state prior to the insertion of the second housing member into the hollow of the first housing member,
the second member ceiling wall of the second housing member has a second member rib protruding toward the arch ceiling wall of the first housing member in the state prior to the insertion of the second housing member into the hollow of the first housing member, and
at least a part of each of the first member rib of the first housing member and the second member rib of the second housing member is crushed through the insertion of the second housing member into the hollow of the first housing member.

8. The vehicle door checker according to claim 1, wherein the arch part of the first housing member faces the other main face of the basal part, and has an arch ceiling wall provided with an insertion window which allows insertion of the check plate therethrough and two arch side walls respectively connecting opposite side ends of the arch ceiling wall and the other main face of the basal part to each other,
the check plate has a stopper at other end of the check plate that is opposite to the one end in the longitudinal direction of the check plate, and
the arch ceiling wall of the first housing member has an edge portion surrounding the insertion window to receive the stopper by contact with the stopper at a movement end of the check plate.

9. The vehicle door checker according to claim 1, wherein the first housing member further has a fastener made of a bolt or a nut for attachment to the other of the body and the door, and
the fastener is fixed to the basal part of the first housing.

10. The vehicle door checker according to claim 1, wherein the elastic member includes a coil spring, and
the second housing member further includes an end coil position restrictor that restricts positional shift of an end coil of the coil spring, the end coil position restrictor constituting a portion of an inner wall surface of the second housing member that faces a space accommodating the sliding guide and the elastic member.

11. The vehicle door checker according to claim 1, wherein at least one of the first housing member or the second housing member further includes a check plate side surface restrictor that restricts vibration of the check plate in a direction intersecting the longitudinal direction of the check plate and a direction in which the sliding guide comes into contact with the check plate at the movement of the check plate, the check plate side surface restrictor constituting a portion to come into contact with or being adjacent to a side surface of a portion of the check plate to be inserted in the housing.

12. The vehicle door checker according to claim 1, wherein, in a plan view of the sliding guide in a direction in which the sliding guide comes into contact with the one main surface of the check plate,
the sliding guide has an outer edge forming an arc at a position opposite to the basal part of the first housing member.

13. The vehicle door checker according to claim 2, wherein the housing further includes a connecting member that connects the first housing member and the second housing member to each other.

14. The vehicle door checker according to claim 2, wherein an insertion direction for insertion of the second housing member into the hollow of the first housing is defined as a first direction, and a direction in which the arch part protruding from the basal part of the first housing member is defined as a second direction,
the second housing member has a pair of side walls extending in the first direction and facing each other,
each of the pair of side walls of the second housing member has a protrusion protruding toward the basal part of the first housing member in the second direction and extending in the first direction, and
the basal part of the first housing member has a groove on the other main face of the basal part to receive the protrusion inserted therein.

15. The vehicle door checker according to claim 2, wherein the second housing member has a second member ceiling wall facing the other main face of the basal part of the first housing member at the fixed attachment of the second housing member to the first housing member,
the arch part of the first housing member has an arch ceiling wall facing the other main face of the basal part, and has a first member rib protruding toward at least one of the second member ceiling wall or the second member side wall of the second housing member in a state prior to the insertion of the second housing member into the hollow of the first housing member,
the second member ceiling wall of the second housing member has a second member rib protruding toward the arch ceiling wall of the first housing member in the state prior to the insertion of the second housing member into the hollow of the first housing member, and
at least a part of each of the first member rib of the first housing member and the second member rib of the second housing member is crushed through the insertion of the second housing member into the hollow of the first housing member.

16. The vehicle door checker according to claim 2, wherein the arch part of the first housing member faces the other main face of the basal part, and has an arch ceiling wall provided with an insertion window which allows insertion of the check plate therethrough and two arch side walls respectively connecting opposite side ends of the arch ceiling wall and the other main face of the basal part to each other,
the check plate has a stopper at other end of the check plate that is opposite to the one end in the longitudinal direction of the check plate, and
the arch ceiling wall of the first housing member has an edge portion surrounding the insertion window to receive the stopper by contact with the stopper at a movement end of the check plate.

17. The vehicle door checker according to claim 2, wherein the first housing member further has a fastener made of a bolt or a nut for attachment to the other of the body and the door, and
the fastener is fixed to the basal part of the first housing.

18. The vehicle door checker according to claim 2, wherein the elastic member includes a coil spring, and
the second housing member further includes an end coil position restrictor that restricts positional shift of an end coil of the coil spring, the end coil position restrictor constituting a portion of an inner wall surface of the second housing member that faces a space accommodating the sliding guide and the elastic member.

19. The vehicle door checker according to claim 2, wherein at least one of the first housing member or the second housing member further includes a check plate side surface restrictor that restricts vibration of the check plate in a direction intersecting the longitudinal direction of the check plate and a direction in which the sliding guide comes into contact with the check plate at the movement of the check plate, the check plate side surface restrictor constituting a portion to come into contact with or being adjacent to a side surface of a portion of the check plate to be inserted in the housing.

20. The vehicle door checker according to claim 2, wherein, in a plan view of the sliding guide in a direction in which the sliding guide comes into contact with the one main surface of the check plate,
the sliding guide has an outer edge forming an arc at a position opposite to the basal part of the first housing member.
